(19) United States
(12) Patent Application Publication
(10) Pub. No.: US 2026/0080793 A1
(43) Pub. Date: Mar. 19, 2026

(54) DETECTING AND PREVENTING USE OF MULTIPLE DISPLAYS IN AN EXAMINATION

(71) Applicant: EXAMROOM.AI CORP., Lake Mary, FL (US)

(72) Inventors: Vinod Kumar JAYAKEERTHI, Sorrento, FL (US); Parshant KUMAR, Bangalore (IN); Ravichandra PANCHAKSHARAM, Bangalore (IN)

(73) Assignee: EXAMROOM.AI CORP., Lake Mary, FL (US)

(21) Appl. No.: 19/290,584

(22) Filed: Aug. 5, 2025

Related U.S. Application Data
(60) Provisional application No. 63/694,258, filed on Sep. 13, 2024.

(51) Int. Cl. G09B 7/00; G06F 3/14

(52) U.S. Cl. CPC G09B 7/00; G06F 3/14

(57) ABSTRACT

Embodiments of the present disclosure are related to a method, system and computer program product to monitor and detect additional display devices coupled to a candidate device in an examination environment, where the candidate device is being administered the examination, and embodiments of the present disclosure include preventing mirroring of examination of content from the candidate device on the additional display devices coupled to the candidate's device providing a secure examination environment.

### RELATED APPLICATION

This application claims the benefit of priority to U.S. Provisional Patent Ser. No. 63/694,258 filed on Sep. 13, 2024 titled “PREVENTING USE OF MULTIPLE DISPLAYS IN AN ONLINE EXAMINATION ENVIRONMENT” and said U.S. Provisional Patent Ser. No. 63/694,258 is hereby incorporated by reference in its entirety.

### TECHNICAL FIELD

Embodiments of the present disclosure relate to preventing use of multiple displays in an online examination and more specifically to detecting use of multiple displays during an online examination and preventing the use of the multiple displays during an online examination especially when the examination is being administered at a remote location.

### BACKGROUND

Typically, online examinations and online assessment of candidates have been gaining popularity in recent times, and such online examination and assessment methods have been also found to be an effective way of administering examination to candidates under different scenarios. In general, online examination have changed the complete understanding of assessing candidates, specifically assessing candidates irrespective of the location of the candidate, and more specifically candidates in remote location, and such online examination may be advantageously used in conducting universities exams, government exams, other forms of assessment of candidates to name a few amongst the various other possibilities. Under such circumstances, scenarios providing a secure platform for conducting examination may become critical to the authority administering examinations which are used for assessment of the candidates. Several security measures need to be put into place in the online examination environment. Given this, there is a need to detect and fix security related issues at the candidate's location, where the online examination is being administered, providing a secure environment for administering examinations. It is an object of the present disclosure to overcome some deficiencies with respect to online examination security.

### SUMMARY

Embodiments of the present disclosure relate to a system, computer program product, an apparatus, an architecture and a method of providing a secure examination environment, especially in an online examination scenario. An embodiment may include receiving at a candidate device, an examination package (also referred to as broad; y as the test package), the examination package additionally includes other necessary packages (software) in addition to the test package prepared for a particular candidate and/or a group of candidates. In an embodiment the other packages may include and not be limited to an examination application. In an embodiment, the test package being delivered to the candidate device by a test administration server at a scheduled time of the examination. In an embodiment, the test administration server being communicatively coupled to candidate device over network. An embodiment may include administering the test package on the candidate device. In an embodiment the test package may include a test specification, and the test specifications including amongst several parameters defined for the examination, at least a set of test rules to be implemented on the candidate device. An embodiment may include implementing the set of rules on the candidate device prior to commencement of an examination, the examination being administered by an examination application. In an embodiment, implementing the set of rules on the candidate device may include monitoring the candidate device for auto detecting an anomaly with respect to the set of test rules implemented. In an embodiment, the anomaly may include identifying at least one or more additional display devices communicatively coupled to the candidate device during the examination. In an embodiment, on detection of the anomaly, performing an action on the candidate device without any human intervention.

### DESCRIPTION OF THE DRAWINGS

The detailed description is described with reference to the accompanying figures. Features, aspects, and advantages of the subject matter of the present disclosure will be better understood with regard to the following description and the accompanying drawings. The figures are intended to be illustrative, not limiting, and are generally described in context of the embodiments, and it should be understood that it is not intended to limit the scope of the disclosure to these particular embodiments. In the figures, the same numbers may be used throughout the drawings to reference features and components. In order that the present disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages. Novel aspects characteristic of the present disclosure is set forth in the appended claims, embodiments described herein will be understood by those of skill in the art with reference to the following detailed description and accompanying drawing figures in which like reference numerals indicate similar or identical features and components.

FIG. 1A is an illustrative architecture illustrating a test server and a candidate device located remotely or co-located for administering online examination on the candidate device from the test administration server (TAS), the candidate device being connected to the TAS over a network in accordance with an embodiment of the present disclosure.

FIG. 1B is an illustrative setup of a simplistic architecture showing a candidate device in an offline examination environment, wherein external device containing encrypted examination content are provided to the candidate and/or the examination center to couple with the candidate device on which the examination is administered in accordance with an embodiment of the present disclosure,

FIG. 2 illustrates an example architecture of the candidate device for administering an examination on a candidate device remotely located in accordance with the embodiments of the present disclosure.

FIG. 3A is an illustrative setup of a candidate device coupled with a candidate device in an examination environment and the candidate device being connected to one or more additional display devices for mirroring content from the candidate device to the additionally connected devices in accordance with an embodiment of the present disclosure.

FIG. 3B is an illustrative setup of a candidate device coupled a candidate device in an examination environment and the candidate device being connected to one or more additional display devices for mirroring content from the candidate device to the additionally connected devices, and a monitoring logic module activated on the candidate device configured to detect the additionally connected devices, and blank or disable or post notice on the additional connected display devices to the candidate device in accordance with an embodiment of the present disclosure.

FIG. 3C is an illustrative setup of a candidate device coupled a candidate device in an examination environment and the candidate device being connected to one or more additional display devices for mirroring content from the candidate device to the additionally connected devices, and a monitoring logic module activated on the candidate device configured to detect the additionally connected devices, and pause the examination until the additional display devices are disconnected in accordance with an embodiment of the present disclosure.

FIG. 4A is an illustrative setup of a method implementing the monitoring logic module on the candidate device which is configured to detect and monitor additional display devices being connected to the candidate device in an online and/or offline examination environment in accordance with an embodiment of the present disclosure.

FIG. 4B is an illustrative setup of a method of detecting additional display devices coupled with a candidate's device and monitoring the candidate device for additional display devices being added to the candidate device taking preventive measures to during the examination being administered on the candidate device in accordance with an embodiment of the present disclosure.

### DETAILED DESCRIPTION

The following describes technical solutions in exemplary embodiments of the subject matter of the present disclosure with reference to the accompanying drawings. In this application as disclosed herein, “at least one” means one or more, and “a plurality of” means two or more. The term “and/or” describes an association relationship for describing associated objects and represents that three relationships may exist. For example, A and/or B may represent the following cases: Only A exists, both A and B exist, and only B exists, where A and B may be singular or plural. The character “/” usually indicates an “or” relationship between the associated objects. “At least one item (piece) of the following” or a similar expression thereof means any combination of the items, including any combination of singular items (piece) or plural items (pieces). For example, at least one item (piece) of a, b, or c may represent a, b, c, a and b, a and c, b and c, or a, b, and c, where a, b, and c each may be singular or plural. It should be noted that in this application articles “a”, “an” and “the” are used to refer to one or to more than one (i.e., to at least one) of the grammatical object of the article. The terms “comprise” and “comprising” are used in the inclusive, open sense, meaning that additional elements may be included. It is not intended to be construed as “consists of only”. Throughout this specification defined above, unless the context requires otherwise the word “comprise”, and variations such as “comprises” and “comprising”, will be understood to imply the inclusion of a stated element or step or group of elements or steps but not the exclusion of any other element or step or group of elements or steps. The term “including” is used to mean “including but not limited to”. “Including” and “including but not limited to” are used interchangeably. In the structural formulae given herein and throughout the present disclosure, the following terms have been indicated meaning, unless specifically stated otherwise. Unless otherwise defined, all terms used in the disclosure, including technical and scientific terms, have meaning as commonly understood by one of ordinary skill in the art to which this invention belongs. By means of further guidance, term definitions are included for better understanding of the present disclosure. The term ‘about’ as used herein when referring to a measurable value such as a parameter, an amount, a temporal duration, and the like, is meant to encompass variations of ±10% or less, preferably ±5% or less, more preferably ±1% or less and still more preferably ±0.1% or less of and from the specified value, insofar such variations are appropriate to perform the present disclosure. It is to be understood that the value to which the modifier ‘about’ refers is itself also specifically and preferably disclosed. It should be noted that in this application, the term such as “example” or “for example” or “exemplary” is used to represent giving an example, an illustration, or descriptions. Any embodiment or design scheme described as an “example” or “for example” in this application should not be explained as being more preferable or having more advantages than another embodiment or design scheme. Exactly, use of the word such as “example” or “for example” is intended to present a related concept in only a specific manner. In the embodiments of the present subject matter, it should be understood that “B corresponding to A” indicates that B is associated with A, and B can be determined based on A. However, it should be further understood that determining B based on A does not mean that B is determined based on only A. B may alternatively be determined based on A and/or other information. In the embodiments of this present disclosure, “a plurality of” means two or more than two. Descriptions such as ‘first”, “second” in the embodiments of this application are merely used for indicating and distinguishing between described objects, do not show a sequence, do not indicate a specific limitation on a quantity of devices in the embodiments of this application, and do not constitute any limitation on the embodiments of this application.

Embodiments of the present disclosure relate to a system, computer program product, an apparatus, an architecture and a method of providing a secure examination environment, especially in an online examination scenario. An embodiment may include receiving at a candidate device, a examination package (also referred to as broad; y as the test package), the examination package additionally includes other necessary packages (software) in addition to the test package prepared for a particular candidate and/or a group of candidates. In an embodiment the other packages may include and not be limited to an examination application. In an embodiment, the test package being delivered to the candidate device by a test administration server at a scheduled time of the examination. In an embodiment, the test administration server being communicatively coupled to candidate device over network. An embodiment may include administering the test package on the candidate device. In an embodiment the test package may include a test specification, and the test specifications including amongst several parameters defined for the examination, at least a set of test rules to be implemented on the candidate device. An embodiment may include implementing the set of rules on the candidate device prior to commencement of an examination, the examination being administered by an examination application. In an embodiment, implementing the set of rules on the candidate device may include monitoring the candidate device for auto detecting an anomaly with respect to the set of test rules implemented. In an embodiment, the anomaly may include identifying at least one or more additional display devices communicatively coupled to the candidate device during the examination. In an embodiment, on detection of the anomaly, performing an action on the candidate device without any human intervention.

An embodiment may include an action to be performed, and the action may include at least one of disabling the one or more additional display devices. An embodiment may include an action and the action may include at least one of blanking the one or more additional display devices from any content being displayed on the one or more additional display devices. An embodiment may include an action and the action may include at least one of posting a notice the one or more additional display devices such as posting a poster or a screen saver and locking the additional display devices until the examination is completed. An embodiment may include an action and the action may include at least one of passing the examination on the candidate device when the examination application detects a connection being attempted to be made between the candidate device and the one or more additional display devices. In an embodiment the one or more additional display devices may be communicatively coupled to the candidate device by wired means and/or wireless means and/or a combination thereof.

In an embodiment, the candidate device (also referred to herein as candidate computing device) may be communicatively coupled to Test Administration Server (TAS) (sometime also referred to as Examination Administration Server or an Examination Server) and/or proctor device and/or any other external systems coupled to the candidate device for monitoring the candidate device, via a network. The network may include and not be limited to Local Area Network (LAN), Wide Area Network (WAN), Metropolitan Area Network (MAN), Wireless LANs (WLAN), Cloud based networks (CBN). Campus Area Network (CAN), Passive Optical LAN (POLAN), Enterprise private network (EPN), Virtual Private Network (VPN), System Area Network (SAN) and Personal Area Network (PAN), which may be categorized by the size and geographical scope.

An embodiment may include receiving a confirmation from an examination server for a candidate (reference to candidate may also include a group of candidates), after the candidate has scheduled a time for the examination and/or the examination administrator has scheduled a time for the examination and/or a third party on behalf of the client has scheduled a time for the examination (all these hereinafter also generally referred to as a party). In an embodiment the candidate or the party schedules an examination by selecting the examination from a list of examinations provided by at least one of a client, an examining authority, a third party acting on behalf of the client. In an alternate embodiment, if the candidate receives a scheduled time from the examination administrator and/or a client and/or a third party acting on behalf of the client, the candidate may select the examination from a list of examinations provided by at least one of a client, an examining authority, a third party acting on behalf of the client. In an embodiment based on the scheduled time and the selected examination, the examination administrator and/or a client and/or a third party acting on behalf of the client may prepare a examination package, which includes the test package and other related materials, and reference to test package in this disclosure will generally refer to the examination package, and the test package prepared for the candidate may be administered to the candidate in at least one of an online mode or an offline mode.

In an embodiment, the candidate device may be registered at the examination server prior to taking the examination. In an embodiment, registration may include acquiring at least one of a candidate identity and/or a candidate device identity, which may further include obtaining at least one of an IP address of the candidate device, a MAC address of the candidate device, Operating System of the candidate device, and at least one of an application and a browser used by the candidate on which the examination is administered along with the candidate details. In an embodiment, some or all these above-mentioned parameters may additionally be included in the test specifications, which will be a part of the test package. In an embodiment, the test specification may include and not be limited to at least one of a candidate identification number, a candidate authentication profile, a test identif0ication number, a set of languages for administering the test, a test set comprising a plurality of items, a number of parts for each of an item type in the test set, a duration for the test, a type of test, and a set of rules for the test.

In an embodiment, the test specifications form an important part of the test package for the candidate. In an embodiment, the test package may include other packages included and for example may include a separate examination application on which the examination may be administered, or alternatively may include a script or a plugin along, which may be run on the candidate device and the script and/or plugin may be configured to convert a browser on the candidate device into an examination application in which the examination may be administered to the candidate. In an embodiment, the examination application may include performing at least one of downloading the test package onto the candidate device at the scheduled time and/or the examination server may be configured for pushing the test package onto the candidate device at the scheduled time. In an embodiment, the test package may be complied for the candidate by the at least one of the clients, the examining authority (also referred to as examination administrator), and the third party acting on behalf of the client.

In an embodiment, the candidate may be permitted to login to the examination server (also referenced to herein as test administration server or test server) from the candidate device at the scheduled time of the examination. In an embodiment, the candidate device may be co-located at a same geo-location and a vicinity of the examination server. In an embodiment, the candidate device may be co-located at a same geo-location and an alternate vicinity of the examination server. In an embodiment, the candidate device may be located at a remote location from the examination server and the candidate may be administered the examination remotely.

In an embodiment, the set of test rules may be implemented on the candidate device for monitoring the candidate device prior to commencement of the examination. In an embodiment, prior to implementing the set of rules on the candidate device, consent may be obtained from the candidate for implementation of these rules that monitor the candidate device. In an embodiment, on negative determination of consent from the candidate the examination not administered to the candidate on the candidate device. In an embodiment, on obtaining a positive consent from the candidate, the set of test rules for monitoring the candidate device during the examination and scanning the candidate device prior to administering the examination may be activated on the candidate device. In an embodiment, an indicator may be provided on the candidate device that the candidate device is being monitored, which may be a visible indicator displayed on the candidate device. In an embodiment, on at least one of a completion of the examination or an irregular termination of the examination or on logging out from the examination without completion of the examination the monitoring of the candidate device is automatically disabled, and may be further configured to notify the at least one of the client, the examining authority, and the third party acting on behalf of the client in an online administration of the examination. In an embodiment, on at least one of a completion of the examination or an irregular termination of the examination or on logging out from the examination without completion of the examination the monitoring of the candidate device is automatically disabled, and may be further configured to record the events as an evidence for the at least one of the client, the examining authority, and the third party acting on behalf of the client in an offline administration of the examination. In an embodiment, the recording may be encrypted and stored on an external device from which the examination is administered.

In an embodiment, at least one of disabling, blanking or posting a notice on the one or more additional display devices or pausing the examination may include automatically preventing data transmission from the candidate device to the one or more additional display devices coupled to the candidate device. An alternative embodiment may include requesting the candidate to manually disable the one or more additional display devices coupled to the candidate device preventing data transmission between the candidate device and the one or more additional display devices on detection of additional display devices being coupled to the candidate device. An alternative embodiment may include posting a selected notice by the at least one of the clients, the examining authority, and the third party acting on behalf of the client on the one or more additional display devices coupled to the candidate device. In an embodiment, the one or more additional display devices are coupled to the candidate device over a network by at least one of a wired means, a wireless means and a combination thereof. In an embodiment, the monitoring may include a monitoring module configured to auto detect if at least one or more additional display devices is being communicatively coupled to the candidate device during the period of the examination.

An embodiment for monitoring may include detecting and preventing the use of additional (also referred to as multiple also) display devices being coupled to a candidate device in an online examination and/or offline examination environment or pausing the examination, especially while an examination is in progress on the candidate device or anytime post login to the TAS for an online examination. In an embodiment, even if one or more additional display devices are added, such additional displays are detected especially during administration of an online examination and are blanked out and/or disabled from mirroring examination content on the additional display devices or the examination may be paused until such a connection is disabled, with a notice being displayed to the candidate on the candidate device. An embodiment may include detecting and preventing and/or deactivating the use of additional display and/or pause the examination, wherein the examination content may not be mirrored on the additional display devices. In an illustrative embodiment, examination (online and/or offline modes) under current circumstances facilitates assessments of candidates where location of the candidate does not matter and the candidate may not need to be present physically at the examination center to take the examination, thereby saving cost, time, resources including human resources and effort involved in conducting an examination.

In an embodiment, a candidate device may be directly interfaced with TAS over a network, which is typically a secure network, and once the candidate device is coupled to the TAS and/or the authentication process is completed (which is not explained in details as this does not form part of the current disclosure) by the candidate, post-authentication the candidate may be administered the examination online, and/or the examination may be administered via a proctor. In an embodiment, the examination may be administered in an offline mode, where the examination may be typically administered from an external device on which an encrypted examination package is stored and administered on the candidate device. In an embodiment, during the examination the candidate device is continuously monitored to check if any additional display devices are being coupled to the candidate device. In an embodiment, the candidate device may be administered the examination by coupling an external device such as a USB device on which the examination package is bundled and executed on the candidate device. It should be obvious to a person of ordinary skill in the art that several other means of conducting an online examination may be known in the art and that all such variations of conducting an online examination to assess candidates may be covered and included under the embodiments of the present disclosure.

In an embodiment, proctored examination and/or online examinations may be generally timed exams that may be taken while software, such as proctoring software, monitors the candidate's device, for example a candidate's computer system and/or a human proctor monitors the candidate and the candidate's computer system, and additional devices such as webcam video, audio. location etc. In an embodiment, candidates may still find innovative ways to cheat the system (examination environment) and it therefore becomes important to protect and secure the examination content being delivered to the candidate on the candidate device. In an exemplary case, the candidate may use duplicate displays and/or connect multiple displays to the candidate device, which essentially allows the candidate and/or any other party connected to the additional display device to copy and/or record the examination content, which content may then be used and distributed with a malicious intent. An embodiment may advantageously prevent misuse of examination content being delivered from TAS and/or an examination system and/or an external device containing the examination in encrypted form, such that the candidate may not be able to cheat in an examination by copying and/or obtaining help from third parties and/or copy/record content and/or malicious use of the examination content.

In an embodiment, in online examinations involving proctors, proctors may be monitors and gatekeepers of the examination in progress, and the proctors may generally ensure that the candidates have all the necessary resources they need to take the examination, and also further ensure to check whether the candidate is cheating and/or manipulating while taking the examination, thereby ensuring the examination environment is safe, protected, secure and fair to all candidates. In an embodiment, proctors may also explain guidelines and/or rules and/or policies and/or the process for taking the examination on the candidate device, which may be at the same geo-location or remotely located. In an illustrative case, especially for remotely located candidates and/or proctors, duplicate and/or multiple display may still be attached for mirroring examination content, especially display devices having a smaller form factor, such as a portable electronic device, and copies of the examination content may be recorded and/or stored and subsequently distributed, or by mirroring the examination content the candidate may cheat in the examination, as the human proctor may not be able to view a small form factor device that may be easily hidden and may be used for recording the examination content. In an embodiment, candidates may be able to cheat the proctor and/or the proctoring system by adding device without the knowledge of the proctors and/or proctoring system and hence in accordance with the embodiments of the present disclosure, the monitoring module advantageously prevents adding additional display devices to the candidate device.

In an embodiment, consider the scenario where a candidate is being administered the examination in an online mode and/or being interfaced with a proctor and/or taking the examination in an offline mode using an encrypted external device containing the examination content. In an embodiment, in the online scenario the candidate device and/or the proctor device may be interfaced with the TAS. In an embodiment, once the candidate login to the examination server is completed, the candidate may complete the required registration formalities and/or be authenticated by the TAS with details already provided to the TAS and post authentication the candidate may proceed to take the examination online. In an embodiment, an examination application may be used to administer the examination on the candidate device. It should be obvious to a person of ordinary skill in the art that the candidate may connect with the TAS over an Intranet and/or the Internet and/or a combination thereof. In an illustrative case, the TAS may be at the same geo-location as the candidate device and/or may be remotely located and/or may be a cloud-based server and/or may also be a combination thereof.

In an exemplary setup where the candidates prefer using their own device such as and not limited to a laptop and/or a desktop computer and/or portable electronic device and/or any other kind of device that has at least a display and a processor, the candidate device may connect to the TAS, and the examination may be administered on the candidate device. However, as mentioned previously, the examination administrator may need to ensure that proper security measures are in place while administering the examination on the candidate device. It should be obvious again to a person that only a few devices have been mentioned herein and all devices that can display and/or process content fall within the purview of the present discourse. In one exemplary case, a problem with the current online examination environment and/or an offline examination environment is that other devices and/or additional devices (herein including additional display devices) may be connected and/or coupled to the main device (candidate device) on which the examination is being administered. In an exemplary case, these additional display devices may be specifically used for mirroring examination content and copying the examination content, which may be published and/or distributed to others by several means such as directly transmitting content, photos, recordings etc., by using the mirrored content. In another illustrative case, the examination content may be manipulated by the candidate to cheat in the examination when additional display devices are used by the candidate taking the examination.

In a further exemplary embodiment, on detection of additional display devices being coupled to the candidate's device before the commencement of the examination and/or post login during the examination being administered on the candidate device, from the time the examination starts to the time the examination ends, the candidate device is continuously monitored by detecting, monitoring and disabling all externally connected additional display devices used for mirroring examination content displayed on the display of the candidate's device. In an embodiment, the additional display devices may be coupled with the candidate's device by wired means or wireless means or a combination thereof as mentioned previously. In an exemplary case, the additional display devices may be remotely placed from the candidate's device and connected via a VGA port and/or HDMI port and/or USB port and/or a C-type port and/or any other means. In an embodiment, multiple display devices may be coupled with the candidate's device proximate to the candidate device and/or remotely by wired means and/or wireless means and/or a combination thereof, specifically for mirroring the examination content being displayed on the display of the candidate's device. The object of the embodiments of the present disclosure is to detect all additional display devices being coupled to the candidate device and disable content from not being mirrored on the additional display devices and/or pause the examination, until the additional display devices are disconnected from the candidate device.

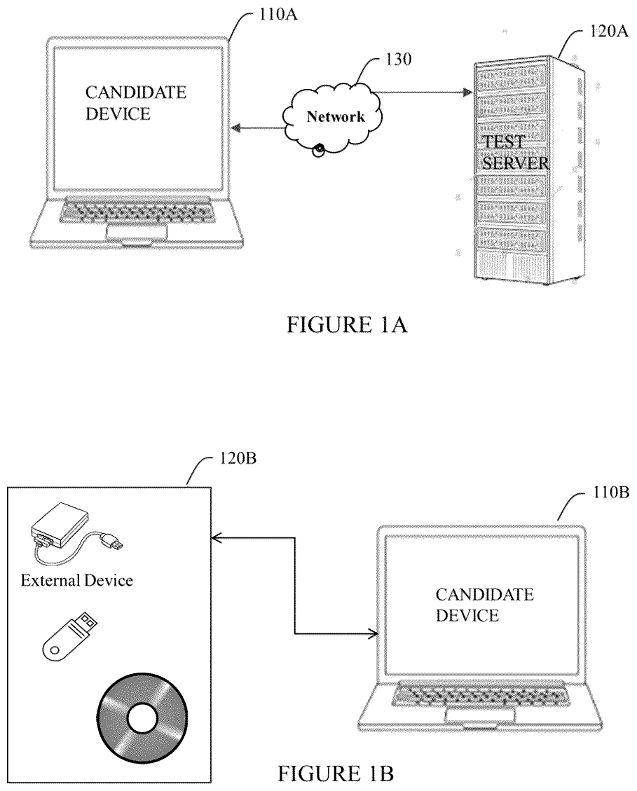

Reference is now made to FIG. 1A, which is an illustrative setup of a simplistic architecture (may also be referenced to as examination environment and/or examination architecture and/or examination setup) showing a test administration server (examination server and/or test server, hereinafter referred to as TAS) and a candidate device in an online examination environment in accordance with an embodiment of the present disclosure. Candidate device 110A is connected to the TAS 120A over network 130. The illustrated architecture may be considered to be the simplest form the architecture for conducting an online examination. The candidate may use candidate device 110A (hereinafter referred to as broadly as device) to couple with TAS 120A (which may be hereinafter referred to as broadly as server), over network 130. Candidate device 110A may be at the same geo-location, co-located and/or remotely located from the location of TAS 120A coupled over a network 130, which may be an Internet connection and/or an Intranet connection and/or a combination thereof. In the simple architecture depicted here, candidate device 110A may be coupled to TAS 120 over the network 130 by wired means, wireless means or a combination thereof, or any other means that are obvious and known to a person of ordinary skill in the art. In an example case, an Air Fiber connection may be used to coupled candidate device 110A to TAS 120A. In an exemplary case, TAS 120 may be a local server and/or a network-based server and/or a cloud-based server and/or a combination thereof. It should be obvious to a person of ordinary skill in the art that many other types of servers may be used as TAS including those mentioned above, and all such variations of servers for hosting examination content and administering an online examination fall within the scope of the present disclosure.

In an exemplary case, TAS 120A may be a cloud-based device coupled to candidate's device 110A over the cloud (network). TAS 120A may be configured to administer the requested/required examination to the candidate, on candidate device 110A at the scheduled time. Requested examination details may be provided by at least one of the clients and/or the examination administrator and/or a third party acting on behalf of the client, wherein the examination details may, for example, contain a list of examination that a candidate may be eligible to choose from. Based on the examination details provided, he candidate may register with TAS 120A and select a scheduled time for the examination to the administered at the scheduled time and/or at least one of the client and/or the examination administrator and/or a third party acting on behalf of the client may alternatively assign the scheduled time or a list of scheduled times and the candidate may select the appropriate time. Based on the test schedule and/or the examination details, a specific and relevant test package (examination package) is created for the candidate.

In an exemplary case, the candidate at the scheduled time may login to TAS 120A from candidate device 110A and the examination may be administered on candidate device 110A. Alternatively, TAS 120A may notify the candidate at periodic intervals providing a reminder to the candidate to login to TAS 120A at the scheduled time, so that the candidate does not miss the examination. In an exemplary case, the notification may be a message, email or any other form of notification chosen by the candidate. A secure link may be established between candidate device 110A and TAS 120A for the examination to be administered to prevent intercepting the examination content from network 130. Several other possibilities of logging into the TAS may be possible at the scheduled time for administration of the examination and all such variations fall within the scope of the present disclosure. In an exemplary case, the candidate may be required to register with the TAS prior to taking the examination by selecting in addition to the test schedule, the exam to be administered, and any other prerequisites such as operating system of device etc. After the candidate has completed logging into TAS 120, TAS 120 may be configured to authenticate the candidate and/or authenticate/validate any other details as requested by the TAS and/or provided by the candidate, and essentially include verifying the credentials of the candidate, such that the examination may be administered on candidate's device 110A in confidence and securely. In an exemplary case, several techniques may be used to login and authenticate the candidate and/or the candidate's device which are well known in the art and all such variation and techniques of authenticating/validating the candidate and/or the candidate's device, including registration of the candidate device's, which are known and currently used and not disclosed herein fall within the scope of the embodiments of the present disclosure. It should also be obvious to a person skilled in the art that the illustration in the present disclosure is only an attempt to provide a simplistic view, and there may be other variations and scenarios possible for conducting an online examination and all such variations and scenarios fall within the purview of the scope of the present disclosure.

In accordance with the embodiments of the present disclosure, any online examination administering system and method may fall within the scope of the embodiments of the present disclosure, where examinations to assess the candidate may be advantageously administered to candidate's on candidate device 110A (reference to a candidate device here may include all electronic devices with at least a memory, a processor and a display). Candidate device 110A being interfaced with a TAS 120A over a network 130. TAS 120 may be essentially controlled by the examination administrator and/or client and/or a third party conducting the examination on behalf of a client and/or a third party acting on behalf of a client and/or any authorized person acting on behalf of the client and/or any authorized person acting on behalf of the examination administrator, to ensure that a fair and secure examination (also referred to as knowledge assessment) may be administered to the candidate. Post login of the candidate, TAS 120A may begin administering the examination to the candidate on candidate's device 110A. In an illustrative case, candidate device 110A may include and not be limited to a laptop, a desktop computer, a PDA or any other portable electronic device such as mobile phone, etc., and in general any device having at least a display, a processor and a memory.

In an exemplary case of the current architecture with candidate device 110A being connected to TAS 120A for administration of examinations, the candidate may couple additional displays devices to main candidate device 110A, which may allow the candidate to manipulate the examination and/or record and copy examination content, by mirroring content displayed of the display of candidate device 110A onto the additional display devices, In an alternative exemplary case, the candidate may seek help from experts and/or others form of help to answer the questions in the examination and/or copy and distribute the examination content. Embodiments of the present disclosure prevent such mirroring of content on the additional displays devices coupled to candidate's device 110A, and thereby ensure that the candidate being administered the examination is not being prompted and/or provided with help from others and/or does not have the option to copy and/or record the examination content for further distribution/publishing to other or offer to sale to others. TAS 120A may include the test package which additionally includes the monitoring module. At the scheduled time, the test package or examination package is either downloaded onto the candidate device and/or pushed onto to the candidate device.

Reference is now made to FIG. 1B, which is an illustrative setup of a simplistic architecture showing a candidate device in an offline examination environment, wherein external device containing encrypted examination content are provided to the candidate and/or the examination center to couple with the candidate device on which the examination is administered in accordance with an embodiment of the present disclosure. With reference thereof, a candidate or an examination center where the candidate is administered an examination may be provided with an external device 120B by at least one of the examination administrators and/or the client and/or a third party acting on behalf of the client. External device 120B may include and not be limited to a USB, external hard drive, CD, DVD etc., on which at least one of the examination administrators and/or the client and/or a third party acting on behalf of the client provides the examination content in encrypted form. External device 120B may be coupled to candidate device 110B on which the examination may be administered. The examination package may contain the examination application and/or a script and/or a plugin and the test package, and the examination package additionally includes a monitoring module. The script and/or the plugin when executed on the browser, in the absence of the examination application, may convert the browser into the examination application. Essentially the external device 120B may autorun a configuration file to install the examination application and then the monitoring module and the examination on candidate device 110B. External device 120B being encrypted prevents other applications from reading and/or recording the examination content from the encrypted external device 120B.

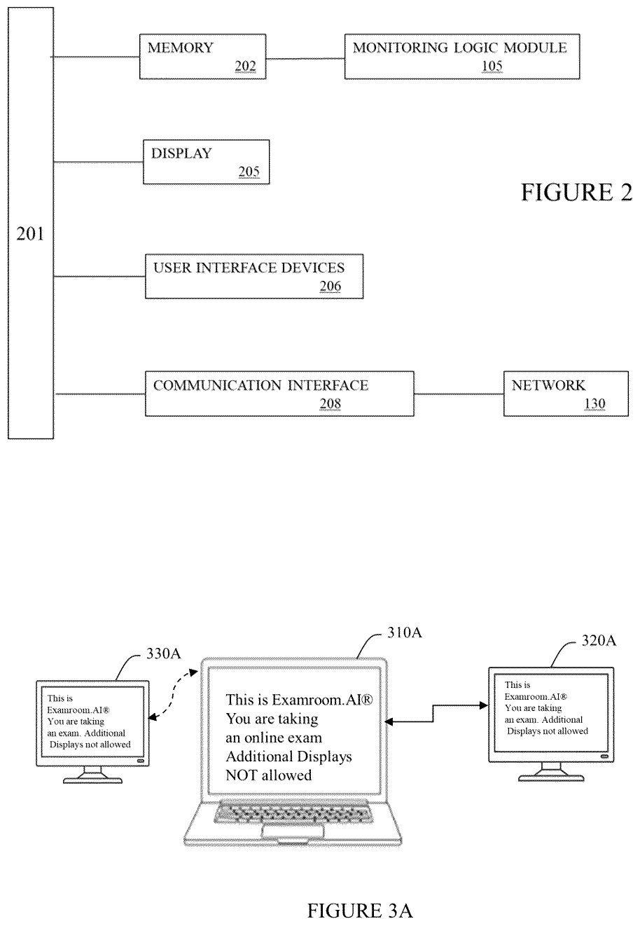

Reference is now made to FIG. 2, which illustrates an example architecture of the candidate device for administering an examination which is remotely located in accordance with the embodiments of the present disclosure. Architecture is described herein with reference to the candidate device 110A, 110B. However, it is contemplated that, as will be appreciated by a person of ordinary skill in the art, that at least some portions of logic componentry and functionality ascribed to candidate device may be incorporated into TAS 120A, into any number of server computing devices, or other computing devices, deployed within proctor device, and/or similar interconnected computing systems, in alternate or additional embodiments of the present disclosure. For instance, it may be contemplated that at least some of the functionality of candidate device 110A, 110B can be implemented and/or incorporated variously, including in portions or an entirety, across other types of server computing systems interconnected therewith via network 130. Monitoring logic module 105, which includes monitoring logic, may be pushed and/or downloaded onto the candidate device 110A, 110B from the TAS 120A post login to the TAS and prior to administration of the examination. Monitoring logic module 105, implementing the monitoring logic as described above in accordance with the embodiments of the present disclosure, may be implemented using programmable instructions stored in memory 202 that are executable in one or more processor devices, including and not limited to processor 201. Memory 202 may include, and not necessarily be limited to, non-volatile memory device(s), including dynamic random access memory (DRAM) or static random access memory (SRAM) non-transitory memory storage media or devices, and/or any combinations thereof. Although functionality ascribed to monitoring logic module 105 as described herein, for sake of providing clarity to a person of ordinary skill in the art, in context of a single discrete logic module, it is expected that functionality ascribed to monitoring logic module 105 herein should not be limited in implementation to such literal configuration and may be constituted of a plurality of functionally equivalent logic modules. In some variations, at least some portions of functionality of monitoring logic module 105 may be implemented in accordance with hard-wired circuitry and/or electronic componentry. The hard-wired circuitry and/or electronic componentry may be, without limitation, such as field programmable gate array (FPGA) devices, application specific integrated circuit (ASIC) devices and similar hard-wired electronic circuitry and/or componentry device implementations.

In an exemplary case, monitoring logic module 105 includes processor-executable instructions stored in memory 202, which, when executed in processor 201, cause processor 201 to implement operations for monitoring of candidate device with rules and/or monitoring parameters and/or mandates that are established by the entity to ensure integrity of remotely administered examinations or even for examination that may be administered at co-located spaces, where the candidate device, TAS and/or proctor are different locations within a co-located space. Monitoring logic module 105 includes processor-executable instructions stored in memory 202, which, when executed in processor 201, cause processor 201 to implement operations for continuously monitoring candidate device during course of the examination being administered on candidate device which may be remotely located and/or co-located in accordance with an monitoring aspect with respect to the monitoring the candidate device to detect any additional display devices being coupled to the candidate device during the course of the examination as disclosed above.

Monitoring logic module 105 further includes processor-executable instructions for detecting, responsive to continuously monitoring the candidate device for any anomaly associated with the candidate device, such as coupling additional display devices to the main candidate device on which the examination is administered. The anomaly may be indications associated with the candidate device that evidences an attempt to contravene the monitoring parameter, which includes parameters to detect additional display devices being coupled to the candidate device, as discussed above which may be defined in the examination rules and/or examination mandate to be managed during administration of the examination on the candidate device.

Monitoring logic module 105 also includes processor-executable instructions for activating blanking and/or disabling and/or posting a selected poster and/or pausing the examination upon detecting the anomaly of additional display devices coupled to the main candidate device, where the selected poster may be an image selected by the examination administrator and/or the client and/or the third part acting on behalf of the client, and pausing the examination may display a notice on the candidate device.

On detection of additional display devices being coupled to the candidate device during the course of the examination and while pausing the examination and/or disabling and/or deactivating and/or blanking and/or posting a poster on the additional display device the candidate may be provided a notification and the proctor and/or the examination administrator may also be notified, and such deviations may be recorded for purpose of evidence in any arbitration proceeding that may be initiated by the candidate and/or the examination administrator and/or the client and/or the third part acting on behalf of the client, which is in contravention of the parameters set forth by the examination rules. In an exemplary case, results of the monitoring that are recorded may include annotations evidencing such attempts by the candidate. Monitoring logic module 105 includes processor-executable instructions for transmitting, to a proctor and/or the examination administrator, an alert based on the monitoring the candidate device for detecting the additional display devices being coupled to the candidate's device. Monitoring logic module 105 includes processor-executable instructions for receiving from the proctor and/or the examination administrator based on the alert, an intervention for decoupling the additional display devices from the candidate's main device.

Monitoring logic module 105, containing the monitoring logic, may be configured to monitor the candidate device during the course of the examination, which may be implemented in an exemplary form in the form of a script or plugin. The script may be pushed from the TAS post login by the candidate from the candidate device, which may be performed automatically or may be part of the test package pushed to candidate device post login to TAS. Alternatively, the script or plugin may be downloaded on the candidate by prompting the candidate or may be done automatically after the candidate logs into to the test server or may be part of the test package downloaded to candidate device post login to TAS. In an offline mode, the monitoring logic module may be autorun from the external device provided when coupled to the candidate device. Monitoring logic module 105 ensures that consent is obtained from the candidate prior to executing the monitoring logic and activating the monitoring logic to begin monitoring the candidate device. Monitoring logic performs monitoring the candidate device to auto detect an anomaly with respect to the examination rules, wherein the anomaly specifically relates to detecting at least one or more additional display devices communicatively coupled to the candidate device during the period of the examination. On detection of the anomaly, monitoring logic is configured for performing at least one of pausing the examination until the additional display devices are removed and/or disabling and/or blanking and/or pushing a poster to the one or more additional display devices communicatively coupled to the candidate device without any human intervention and/or pausing the examination with a notice on the candidate device, thereby preventing examination content being mirrored on the one or more additional display devices.

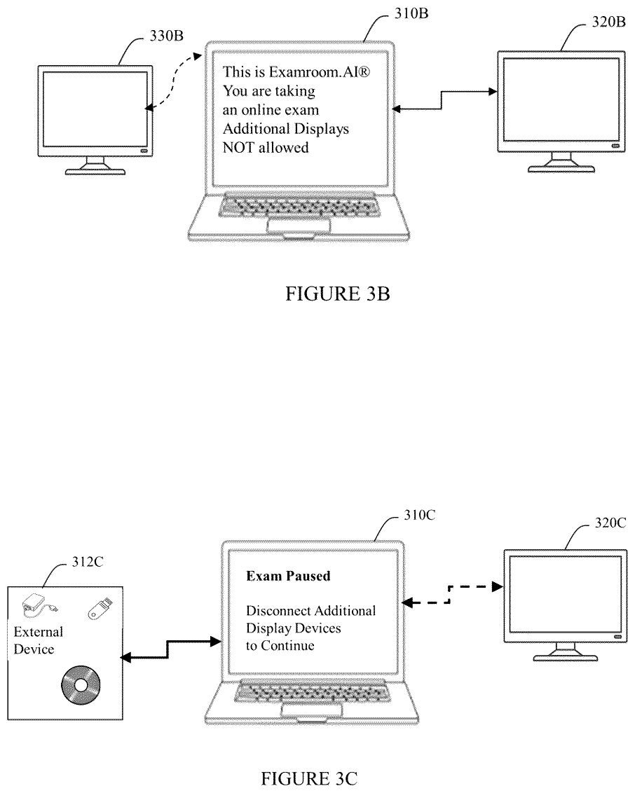

Reference is now made to FIG. 3A, which is an illustrative setup of an examination environment with the candidate device being connected to one or more additional display devices for mirroring content from the candidate device to the additionally connected display devices in accordance with an embodiment of the present disclosure. As illustrated, in an exemplary case, candidate's device 310A, such as a desktop, laptop, PDA, mobile phone etc., on which the examination is being administered, may be coupled to at least one or more additional display device 320A, 330A, compromising on the examination content by mirroring the examination content displayed on candidate's device 210 onto the additional display devices 320A, 330A.

In an exemplary case, such additional display devices 320A, 330A may be generally referred to as mirror displays or extended displays. In an exemplary case, examination content appearing on the display of the candidate device 310A is mirrored onto the additional display 320A, 330A, when the additional display devices 320A, 330A are coupled to the candidate device 310A. As mentioned previously, the additional display devices 320A and 330A may be standalone display devices such as a television screen or a computer screen or any other devices having a display as mentioned previously, where for example devices with a smaller form factor such as a mobile phone may be used. Mirroring content from the candidate's device 310A may be used to record and/or copy and/or store the examination being administered. In an alternative exemplary case, mirroring of content may be used by the candidate to seek help from others and/or experts to answer the examination question. As illustrated, candidate device 310A connects to the TAS (shown in FIG. 1) in an online mode, where the examination for assessment of the candidate is accessed and administered from the test server 120. In an alternate exemplary case, candidate device 310A may be coupled with an external device, such as a USB which is bundled with the encrypted test package and coupled to one of the ports of candidate device 310A, where the examination is administered after coupling the external device to the candidate device. In the offline mode the monitoring logic identified the encrypted external device and allows functionality of the external device but does not allow additional display devices 320A, 330A to be coupled to candidate device 310A

During the course of the examination or prior to the exam beginning, candidate device 310A may be coupled to one or more additional display device 320A by wired means illustrated by the solid line. During the course of the examination or prior to the exam beginning, candidate device 310A may be coupled to one or more additional display device 330A by wireless means illustrated by the dotted line. In another illustrative case (not shown in the figure) and/or more additional display device 320A, 330A may be coupled to the candidate device 310A by a combination of a wired means and a wireless means. It should be obvious to a person of ordinary skill in the art that the illustration shows two additional display devices coupled to the candidate device and in general multiple additional display devices may be coupled to the candidate device, and/or a proctor device, where the proctor may be monitoring the examination and/or monitoring the candidate, and all such variations fall within the scope of the present disclosure.

In an exemplary case, when multiple additional display devices 320A and 330A are coupled to candidate device 310A, content that is displayed on candidate device 310A may be simply extended onto or mirrored onto the additional display devices 320A, 330A. By mirroring content from candidate device 310A to additional display devices 320A, 330A, an exact copy of the content displayed on the candidate device 310A will be made available on additional display devices 320A, 330A. Therefore, when an examination is in progress and/or being administered to a candidate on candidate device 310A, any additional display devices 320A, 330A that are coupled to candidate device 320A, 330A that are active will mirror the examination content compromising on the examination content, which may be copied and/or recorded and/or distributed and/or stored and/or may be also be used by the candidate to seek help in answering the examination questions from third parties by ascertaining answer to the examination questions that are being administered, and the very purpose of a fair examination, fair assessment and a secure examination of the candidate is defeated. Therefore, to increase confidence of the examination administrator and/or the client, it becomes necessary to ensure that the examination content is displayed only on candidate device 310A and the examination content is not being replicated and/or mirrored on any additional device 320A, 330A, especially when additional display devices 320A, 330A are coupled to candidate device 310A during the course of the examination or prior to commencement of the examination.

Reference is now made to FIG. 3B, which is an illustrative setup of a candidate device coupled a candidate device in an examination environment and the candidate device being connected to one or more additional display devices for mirroring content from the candidate device onto the additionally connected devices, and a monitoring logic module activated on the candidate device configured to detect the additionally connected devices, and blank or disable or post notice on the additional connected display devices to the candidate device in accordance with an embodiment of the present disclosure. In the exemplary case, additional display devices 320B, 330B may be coupled to candidate device 310B. In an exemplary case, monitoring logic module may be provided to the candidate to be implemented on the candidate device on which the examination is being administered, and monitoring logic is activated on the candidate device. In an exemplary case, the monitoring logic module may be a script and/or a plugin and/or a program when executed and activated on candidate device 310B may be configured to continuously check and monitor candidate device 310B until completion of the examination. Monitoring logic implemented via monitoring logic module identifies at least one or more additional display devices 320B, 330B that are being coupled to candidate device 310B, and monitoring logic module may be further configured to blank out and/or deactivate and/or disable and/or post with a static poster on the one or more additional devices 320B, 330B, which may include invoking system level calls and procedures such that mirroring of the examination content onto the one or more additional display devices 320B, 330B is disabled, and therefore becomes a preventive measure for the candidate being administered the examination from performing any malpractice and/or malicious activity with respect to the examination content as described previously. Additional display devices 320B, 330B connected to the candidate device 310B will be blanked and/or disabled and/or a static poster may be posted on the additional display devices specifically for the duration of the examination or until the time the candidate device is de-coupled from the examination server, which indicates the examination is no longer active on the candidate device. Alternatively, in another exemplary case, upon identification of additional display devices 320B, 330B being coupled to the candidate device, monitoring logic module may invoke system level calls and functions to stop transmission of data between the candidate device and the additional display device 320B, 330B.

In an exemplary case, all additional display devices 320B, 330B coupled to candidate device 310B will be blanked/deactivate/disabled as a preventive measure of security for the purpose of taking the examination by the monitoring logic module that is active on candidate device 310B during the course of the examination, and the monitoring logic module ensures that no examination content from candidate device 310B will be displayed on one or more additional display devices 320B, 330B until the examination is completed. At the scheduled time of the examination, a candidate may login to the TAS, and the TAS authenticates and/or validates the candidate and performs at least one of pushing the test package onto candidate device 310B or the test package is downloaded from the TAS. The Test package contains the monitoring logic module, which is executed on candidate device 310B. In an offline mode, the test package is encrypted into a external device and provided to the examination center and/or the candidate, which when coupled to the candidate device may be configured to install the test package containing the monitoring logic module onto the candidate device.

In an illustrative embodiment, the monitoring logic module checks the candidate device thoroughly, detects and ascertains without any human intervention (automatically) if there are any additional display devices 320B, 330B coupled to candidate device 310B, where the additional display devices may be coupled to the candidate device by either one of a wired means, wireless means or a combination thereof. On detection of any additional display devices 320B, 330B being coupled to the candidate device, the monitoring logic module may be configured to automatically blank out/deactivate and/or post a poster (notice) on the additional display devices. In an exemplary case, the monitoring logic module may be configured to access and implement system level calls and functions to disable the one or more additional display devices. The monitoring logic module may additionally collect other information of candidate's device 310B such as IP address, MAC address, OS used etc., which may be used as proof and/or evidence for any arbitration in case of any disputes that may arise. In an exemplary case, blanking/deactivating/posting notice on additional display devices may be performed by the same monitoring logic module and/or any other module coupled with the test package specifically to address such issues used to blank/deactivate/post notices on the additional display devices, which for example may include invoking system level call and functionalities specifically for disabling the additional display devices. In an exemplary case, instead of blanking/deactivating the additional display devices, the monitoring logic module may force random characters to be displayed on the additional display devices or form random patterns to be displayed on the additional display devices. It should be obvious to a person of ordinary skill in the art that several other techniques and methods may be executed such that examination content is not mirrored on the additional display devices and all such variation fall within the scope of the embodiments of the present disclosure.

In an online examination scenario, candidates couple to the TAS from candidate device 310B, via various methods at the scheduled time of the examination and these techniques do not fall into the scope of the embodiments of the present disclosure. At the scheduled time of the examination, candidate's login from the candidate device 310B to the TAS (shown in FIG. 1), and TAS may be configured to authenticate/validate and verify the candidate's credentials and any other required pre-defined credentials before administering the examination to the candidate on the candidate device. After validation of the candidate by the TAS, TAS either pushes the test package onto the candidate's device 310B which is executed on the candidate device and/or may request the candidate to download the test package and execute a script post login, wherein the test package may run automatically and/or may be forced to run on the candidate device 310B, after obtaining consent of the candidate. The test package may contain the examination application and the monitoring logic module, wherein the monitoring logic module is first installed to check the candidate device for any additional display devices being coupled to the candidate device and then continuously monitor the candidate device util completion of the examination to detect any additional display devices being coupled to the candidate device. In an offline mode, the entire examination package is bundled onto an external device and the logic is executed in sequence as for the online examination.

The monitoring logic module when executed and active on the candidate device is designed to check, monitor and detect any additional display devices 320B, 330B being coupled to the candidate device 310B, where examination content being displayed on the display of the candidate's device 310B may be mirrored onto the one or more additional display devices, and the additional display devices may either be in extended display mode or mirror mode or any other mode. In an exemplary case, the monitoring logic module may automatically invoke the operating system call and functions and disable all additional display devices 320B, 330B coupled to candidate device 310B for the time/duration of the examination and/or may invoke and execute another script and/or program which may disable content being mirrored on the additional display devices 320B, 330B or display random character or patterns on the additional display devices. In an exemplary case, such an environment prevents mirroring of examination content onto additional display device 320B, 330B, which thereby prevents the examination content from being recorded and/or copied and/or stored and/or distributed to others, and/or may also be used by a candidate to seek help in answering the examination questions by third parties. Disabling mirroring of content on the additional display devices 320B, 330B ensures that a secure and fair examination may be administered on the candidate's device 310B. Alternatively, the monitoring logic module may in an exemplary case instruct the candidate to disable all additional displays 320B, 330B coupled to the candidate's device 310B, and stop/pause the examination until the additional display devices 320B, 330B are disabled, before the examination is administered or continuing the examination, failing which the examination is not administered.

Reference is now made to FIG. 3C, which is an illustrative setup of a candidate device coupled a additional display devices in an examination environment and preventing mirroring content from the candidate device to the additionally connected display devices in accordance with an embodiment of the present disclosure. A monitoring logic module activated on the candidate device is configured to detect the additionally connected devices and pause the examination until the additional display devices are disconnected. Candidate device 310C is coupled to external device 312C, which contains the encrypted test package, which may additionally include the examination application and the monitoring logic module. Once external device 312C is coupled to candidate device, examination application and monitoring logic module is executed/installed on candidate device 310C. Post installation of the monitoring logic module on the candidate device and setting the status of the monitoring logic module to an active state, the monitoring logic module may be configured to check and monitor candidate device 310C for any additional display devices 320C being coupled to candidate device 310C. A check is performed prior to commencement of the examination and the candidate device is continuously monitored during the period of the examination. On detection of one or more display devices coupled to the candidate device, the monitoring logic module may be configured to pause the examination and record any such unusual anomaly for potential evidence for any disputes that may arise. On detection of additional display device 320C, the examination is paused until the monitoring logic module detect that no additional display devices 320C are coupled to the candidate device, and external device 312C is still coupled to candidate device 310C, from which the examination is administered to on candidate device 310C. Alternatively, the monitoring logic module may in an exemplary case instruct the candidate to disable all additional displays 320C coupled to the candidate's device 310B, and stop/pause the examination until the additional display devices 320C are disabled and/or removed and/or detached from the candidate device, before the examination is administered and/or continued on the candidate device, failing which the examination is not administered and/or continued. In an additional embodiment, the monitoring logic module may execute system level calls as mentioned with respect to FIG. 3B to disable transmission of data between the candidate device and any other additional display devices.

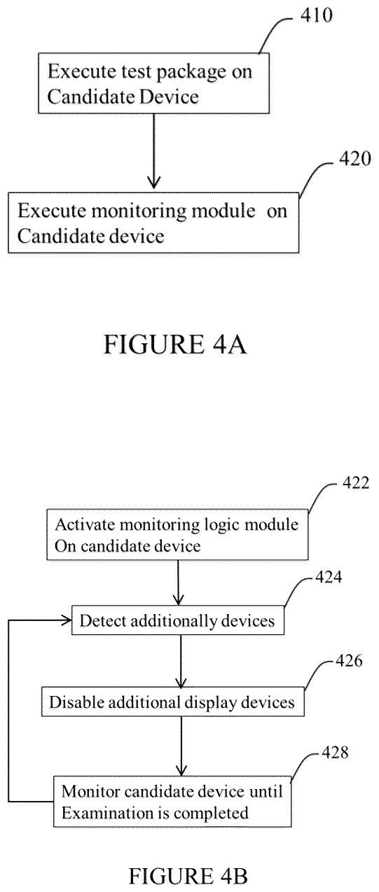

Reference is now made to FIG. 4A, which is an illustrative setup of a method implementing the monitoring logic module on the candidate device which is configured to detect and monitor additional display devices being connected to the candidate device in an online and/or offline examination environment in accordance with an embodiment of the present disclosure. In step 410, the method includes receiving at a candidate device a test package. The test package is prepared for a candidate based on a selection made by the candidate of the examination and the scheduled time and/or any other parameters selected by the candidate s described previously. In an online mode the test package being delivered to the candidate device by a test administration server at a scheduled time of the examination. In the offline mode the test package is bundled into an external device such as a USB, SSD etc, and the test package is encrypted, and the encrypted external device is provided to the candidate and/or an examination centre that may administer the examination to the candidate.

In step 420, the test package is executed on the candidate device, wherein the test package includes a test specification, and the test specifications comprising at least a set test rules and implementing the set of rules on the candidate device prior to commencement of an examination, the examination being administered by an examination application. The test package including an examination application and a monitoring logic module, where the monitoring logic module comprises the set of rules to be implemented on the candidate device prior to the examination being administered on the candidate device. The monitoring logic module is configured to check and monitor the candidate device. In this specific case, the monitoring logic module amongst others is configured to detect and disable additional display devices coupled to the candidate device as described previously

Reference is now made to FIG. 4B, which is an illustrative setup of a method of detecting additional display devices coupled with a candidate's device and monitoring the candidate device for additional display devices being added to the candidate device taking preventive measures to during the examination being administered on the candidate device in accordance with an embodiment of the present disclosure. Processes described above with respect to FIG. 3A-3C of authenticating the candidate, validating he candidate and verifying the candidate are not repeated. In step 422 on executing the test package, first the monitoring logic module is implemented and activated on the candidate device. In step 424, the monitoring logic module may be configured to perform a check and detect if there are any additional display devices that are coupled to the candidate device, prior to commencement of the examination on the candidate device. Post the examination being administered on the candidate device, the monitoring logic module is configured to continuously monitor the candidate device until the end of the examination and/or completion of the examination.

In step 426, any additional display devices detected are disabled and/or blanked and/or deactivated and/or the examination is paused such that content is not mirrored onto the additional display devices coupled to the candidate device as described previously. In the case the examination is paused, the examination is not re-started to be continued until the additional display device is removed and/or detached from the candidate device. In step 428, the candidate device is continuously monitored until the completion of the examination and the steps 424-428 are repeated continuously until the examination is completed. Other embodiments have been described and discussed previously with respect to FIGS. 3A-3C.

Although the present disclosure has been described with reference to several preferred embodiments, it should be understood that the present disclosure is not limited to the preferred embodiments disclosed here. Embodiments of the present disclosure are intended to cover various modifications and equivalent arrangements within the spirit and scope of the appended claims. Although the foregoing disclosure has been described in some detail for purposes of clarity of understanding, it will be apparent that certain changes and modifications may be practiced within the scope of the appended claims. Examples of the present disclosure have been described in language specific to structural features and/or methods. It should be noted that there are many alternative ways of implementing both the process and apparatus of the present invention. Accordingly, embodiments of the present disclosure are to be considered illustrative and not restrictive, and the invention is not to be limited to the details given herein but may be modified within the scope and equivalents of the appended claims. It should be understood that the appended claims are not necessarily limited to the specific features or methods described. Rather, the specific features and methods are disclosed and explained as examples of the present disclosure.

What is claimed is:

1. A method of providing a secure examination environment, the method comprising:
receiving at a candidate device a test package, the test package prepared for a candidate based on a selection made by a candidate of the scheduled time and an examination, wherein at least one of:
the test package being delivered to the candidate device by a test administration server at a scheduled time of the examination OR
the test package being delivered to a candidate in an external device, wherein the test package is encrypted;
administering the test package on the candidate device, wherein the test package comprises a test specification, and the test specifications comprising at least a set of test rules and implementing the set of rules on the candidate device prior to commencement of an examination, the examination being administered by an examination application; and
implementing the set of rules on the candidate device comprises:
monitoring the candidate device for auto detecting an anomaly with respect to the set of test rules implemented. wherein the anomaly comprises identifying at least one or more additional display devices communicatively coupled to the candidate device during the course of the examination; and
on detection of the anomaly, performing an action on the candidate device without any human intervention.

2. The method of claim 1, wherein the action comprises at least one of disabling the one or more additional display devices, blanking the one or more additional display devices, posting a notice on the one or more additional display devices or pausing the examination on the candidate device, wherein the one or more additional display devices is communicatively coupled to the candidate device.

3. The method of claim 1, further comprising:
receiving a confirmation from an examination server for a candidate, wherein the candidate schedules an examination by selecting the examination from a list of examinations provided by at least one of a client, an examining authority, a third party acting on behalf of the client; and
performing at least one of downloading the test package onto the candidate device or pushing the test package onto the candidate device at the scheduled time from the test administration server, wherein the test package complied for the candidate by the at least one of the clients, the examining authority, and the third party acting on behalf of the client.

4. The method of claim 1, further comprising:
permitting a candidate to login to the examination server from the candidate device at the scheduled time, wherein the candidate device is located at least one of:
a same location and a vicinity of the examination server;
a same location and an alternate vicinity of the examination server; and
a remote location from the examination server.

5. The method of claim 1, wherein the candidate device is registered at the examination server by acquiring at least one of a candidate device identity, an IP address of the candidate device, a MAC address of the candidate device, Operating System of the candidate device, and at least one of an application and a browser used by the candidate on which the examination is administered along with the candidate details.

6. The method of claim 5, wherein at least one of a script or a plugin converts a browser on the candidate device into an examination application.

7. The method of claim 1, further comprising:
implementing the set of test rules on the candidate device for monitoring the candidate device comprises:
obtaining consent from the candidate, and on negative determination of consent from the candidate the examination not administered to the candidate on the candidate device.

8. The method of claim 7, further comprising:
on obtaining a positive consent from the candidate, activating the set of test rules for monitoring the candidate device during the examination; and
providing an indicator to the candidate on the candidate device that the candidate device is being monitored.

9. The method of claim 1, wherein on at least one of a completion of the examination. an irregular termination of the examination or on logging out from the examination without completion of the examination the monitoring of the candidate device is automatically disabled.

10. The method of claim 2, wherein at least one of disabling, blanking or posting a notice on the one or more additional display devices or pausing the examination comprises at least one of:
automatically preventing data transmission from the candidate device to the one or more additional devices; or
requesting the candidate to manually disable the one or more additional display devices coupled to the candidate device preventing data transmission between the candidate device and the one or more additional display devices;
posting a selected notice by the at least one of the clients, the examining authority, and the third party acting on behalf of the client the one or more additional display devices coupled to the candidate device;
wherein the one or more additional display devices are coupled to the candidate device by at least one of a wired means, a wireless means and a combination thereof.

11. An architecture comprising a candidate device for providing a secure examination environment, the candidate device comprising one or more processors; a memory storing instructions executable in the one or more processors, the instructions, when executed in the one or more processors, causing the one or more processors of the candidate device to implement operations comprising:
receiving at a candidate device a test package, the test package prepared for a candidate based on a selection made by a candidate of the scheduled time and an examination, wherein at least one of:
the test package being delivered to the candidate device by a test administration server at a scheduled time of the examination OR
the test package being delivered to a candidate in an external device, wherein the test package is encrypted;
administering the test package on the candidate device, wherein the test package comprises a test specification, and the test specifications comprising at least a set test rules and implementing the set of rules on the candidate device prior to commencement of an examination, the examination being administered by an examination application; and
implementing the set of rules on the candidate device comprises:
monitoring the candidate device for auto detecting an anomaly with respect to the set of test rules implemented. wherein the anomaly comprises identifying at least one or more additional display devices communicatively coupled to the candidate device during the course of the examination; and
on detection of the anomaly, performing an action on the candidate device without any human intervention.

12. The architecture of claim 11, wherein the action comprises at least one of disabling the one or more additional display devices, blanking the one or more additional display devices, posting a notice on the one or more additional display devices or pausing the examination on the candidate device, wherein the one or more additional display devices is communicatively coupled to the candidate device.

13. The architecture of claim 11, further comprising:
receiving a confirmation from an examination server for a candidate, wherein the candidate schedules an examination by selecting the examination from a list of examinations provided by at least one of a client, an examining authority, a third party acting on behalf of the client; and
performing at least one of downloading the test package onto the candidate device or pushing the test package onto the candidate device at the scheduled time from the test administration server, wherein the test package complied for the candidate by the at least one of the client, the examining authority, and the third party acting on behalf of the client.

14. The architecture of claim 11, further comprising:
permitting a candidate to login to the examination server from the candidate device at the scheduled time, wherein the candidate device is located at least one of:
a same location and a vicinity of the examination server;
a same location and an alternate vicinity of the examination server; and
a remote location from the examination server.

15. The architecture of claim 11, wherein the candidate device is registered at the examination server by acquiring at least one of a candidate device identity, an IP address of the candidate device, a MAC address of the candidate device, Operating System of the candidate device, and at least one of an application and a browser used by the candidate on which the examination is administered along with the candidate details, and wherein at least one of a script or a plugin converts a browser on the candidate device into an examination application.

16. The architecture of claim 11, further comprising:
implementing the set of test rules on the candidate device for monitoring the candidate device comprises:
obtaining consent from the candidate, and on negative determination of consent from the candidate the examination not administered to the candidate on the candidate device.

17. The architecture of claim 16, further comprising:
on obtaining a positive consent from the candidate, activating the set of test rules for monitoring the candidate device during the examination; and
providing an indicator to the candidate on the candidate device that the candidate device is being monitored.

18. The architecture of claim 11, wherein on at least one of a completion of the examination. an irregular termination of the examination or on logging out from the examination without completion of the examination the monitoring of the candidate device is automatically disabled.

19. The architecture of claim 12, wherein at least one of disabling, blanking or posting a notice on the one or more additional display devices or pausing the examination comprises at least one of:
automatically preventing data transmission from the candidate device to the one or more additional devices; or
requesting the candidate to manually disable the one or more additional display devices coupled to the candidate device preventing data transmission between the candidate device and the one or more additional display devices;
posting a selected notice by the at least one of the clients, the examining authority, and the third party acting on behalf of the client the one or more additional display devices coupled to the candidate device;
wherein the one or more additional display devices are coupled to the candidate device by at least one of a wired means, a wireless means and a combination thereof.

20. A computer-readable non-transitory memory having instructions stored thereon, the instructions when executed in one or more processors causing the one or more processors to implement operations comprising:
receiving at a candidate device a test package, the test package prepared for a candidate based on a selection made by a candidate of the scheduled time and an examination, wherein at least one of:
the test package being delivered to the candidate device by a test administration server at a scheduled time of the examination OR
the test package being delivered to a candidate in an external device, wherein the test package is encrypted;
administering the test package on the candidate device, wherein the test package comprises a test specification, and the test specifications comprising at least a set test rules and implementing the set of rules on the candidate device prior to commencement of an examination, the examination being administered by an examination application;
implementing the set of rules on the candidate device comprises:
monitoring the candidate device for auto detecting an anomaly with respect to the set of test rules implemented. wherein the anomaly comprises identifying at least one or more additional display devices communicatively coupled to the candidate device during the course of the examination; and
on detection of the anomaly, performing an action on the candidate device without any human intervention.
